(19) United States
(12) Patent Application Publication
(10) Pub. No.: US 2005/0060864 A1
(43) Pub. Date: Mar. 24, 2005

(54) Method and means for connecting barbed tubular connectors

(76) Inventors: George Nikolaidis, Paradise (AU); Manfred Imand Kurmis, Wynn Vale (AU)

Correspondence Address: AKERMAN SENTERFITT, P.O. BOX 3188, WEST PALM BEACH, FL, 33402-3188, US

(21) Appl. No.: 10/486,117

(22) PCT Filed: Aug. 6, 2002
(86) PCT No.: PCT/AU02/01038

(30) Foreign Application Priority Data
Aug. 6, 2001 (AU) PR 6831
Dec. 7, 2001 (AU) PR 9341
Feb. 26, 2002 (AU) PS 0736

(51) Int. Cl. B23P 11/00; B23P 19/00

(52) U.S. Cl. 29/432; 29/798

(57) ABSTRACT

A punch (1) for inserting tubular connectors (14) into plastic pipe (6) where there is a long shaft (9) that can project fully through the connector bore (13) and having sharp conical end pierce (11) directly the wall (12) of the tubular pipe (6). There is also disclosed a punch (14) with an automatic supply of tubular connectors (42).

### TECHNICAL FIELD

This invention relates to a method and means for effecting a connection of a barbed tubular connector in the wall of plastic tubing.

### BACKGROUND ART

It is known to have thin wall plastic tubing for transmission of water for irrigation purposes and to connect at spaced apart locations, barbed tubular connectors which are inserted through pierced apertures in the wall of the tubing.

The current method of installing such connectors is to first pierce the wall with a punch and then separately get a tubular barbed connector and push this through the wall to an extent where an end of the barb is passed a periphery of the pierced hole.

This technique is found to be arduous when a number of connectors have to be installed and an object of this invention is to provide both a means and a method which allows the installation method to be less arduous than has hitherto been the case or, at the least, there is provided to the public a useful alternative.

### DISCLOSURE OF THE INVENTION

In one form of this invention, although this need not necessarily be the only or indeed the broadest form of this, there is proposed a punch having a shaft with an outermost sharp end having a diameter and shape such that it will pass fully through the bore of a barbed tubular connector, and means at an inner end of such a shaft whereby to impinge any tubular connector positioned on the shaft so as to enable such a position connector to be pushed with the shaft into an installed position in the wall of a tube.

In a further form of the invention, this can reside in the method of installing a tubular connector which includes the steps of inserting through a central bore of a connector, a shaft having an outermost sharp end and then pushing the sharp end of the shaft through the wall of a tube while, at the same time, pushing the barbed connector so that the barb of the connector passes through and past a periphery of the wall where pierced, and then withdrawing only the shaft.

In preference, in both cases, there are means to hold the plastic tubing which is to be pierced in such a way that the sides of the tube will be retained.

As it will be seen now, the idea is to have a shaft which passes through the tubular bore of a connector so that together they are pushed into the wall of a thin wall plastic tube and such that once the sharp end of the shaft has pierced the wall, the shaft continues to support the tubular connector and this then either with the shaft or by sliding further along the shaft, then enters its barbed end through the pierced hole and, to an extent, that the barb will pass beyond an edge formed by the piercing action in the wall of the tube.

In preference, there is a punch which has a base, a relatively movable arm supported by the base and where there is a shaft extending in the vicinity of an outer end of the arm and extending transversely to any expected relative movement of the arm with respect to the base.

In preference, such a punch has such a shaft so that it can be positioned in at least two relative positioned one being a stored position and another being an operating position.

In preference, there is supported on the base a channel adapted to hold tubing between oppositely facing sides and adapted to restrict outward movement of opposite sides of the wall of plastic tubing when being pierced by the shaft.

In preference, there is also connected to the arm, a blade adapted to be positioned in two relative positions one of which is a stored position, and another of which is an operating position, the operating position being such that when the arm is bought together with the base, the blade is adapted to cut through any plastic tubing that might be being held relative to the base.

In a further form, the invention can reside in a combination punch and inserter for inserting a barbed tubular connector into a larger diameter plastics tubing, the inserter having a shaft having a sharp end and being of a size and shape adapted to extend fully through from end to end of the bore of a barbed tubular connector, and means with the shaft to engage an outer end of the tubular connector when positioned with the shaft extending through the bore of the tubular connector to push against the tubular connector so that this will follow a piercing action of the shaft into the wall of a larger diameter tubing, this being to an extent that the barb of a tubular connector can pass fully through such a wall subsequent to being pierced, and then extract the shaft by pulling this back through the bore of the tubular connector thereby leaving the tubular connector installed.

In another form, the invention can be said to reside in a method of installing a barbed tubular connector in the wall of a larger diameter plastics tubing which includes the steps of locating the barbed tubular connector with a shaft extending fully through a tubular bore of a connector and having an outermost sharper end which projects past the bore of the tubular connector, and then effecting a piercing action with the shaft into the wall of the tubing and effecting a pushing of the connector synchronously with the shaft so as to have its barb fully in the wall of the tubing and then extracting the shaft.

The problem to which this invention is directed relates to providing an economic tool by which barbed tubular connectors can be easily inserted into plastic tubing.

Barbed tubular connectors are conventionally used so as to provide a connection between a main tubular supply of water to a take off having a somewhat smaller tubular diameter in such applications as drip irrigation.

There is a need by which such barbed tubular connectors can be quickly and easily inserted into plastic tubing.

There is a proposal which uses a shaft which passes fully through the tube of a barbed tubular connector so that when directed against the wall of plastic tubing, it is the point of the shaft that first encounters the wall and effectively pierces this then carry through the wall with the shaft, one end of the barbed tubular connector.

By having the shaft pass fully through the center of the axially aligned central bore providing the tubular character of the connector means that the conical pointed end of the shaft can effect the piercing of the wall and the characteristic of the plastics material of the connector does not have to perform this function.

In other techniques for inserting such tubular connectors, a separate tool has been used which has been used to insert and effect a hole so that thereafter, the tubular connector is then inserted into the previously made hole.

The problem with this technique, of course, is that it is much more time consuming to go through the double process of making a hole first and then inserting the tubular connector and further, pressure necessary to insert the tubular connector still needs to be significant and the hands of an operator can become quite tired and sore from this specific process.

Accordingly, there is further proposed, in accordance with this invention, a tool for supporting an insertion shaft by which a tubular connector can be impinged and caused to be inserted through the wall of a plastic tubing, characterized in that the tool is substantially formed from a single strip of metal with an attached sharp ended shaft.

In preference, the metal is spring steel.

In preference, the shape of the strip of metal includes at one end an open U-shape nest into which plastic tubing can be squeezed and held thereby, and at an opposite end, there is secured a shaft so that respective legs can be pressed together whereby the end of the shaft would engage any plastic tubing held by the U-shaped end portion.

In preference, the strip of metal is of substantially uniform width throughout its length, this being provided by a lower leg, an upper leg and an apex.

In preference, in the vicinity of the apex, there is at least one slotted hole through the metal whereby to provide a line of weakness to assist in control of the degree of spring resistance that might be encountered by a user.

In an alternate arrangement, the area in the vicinity of the apex is wasted so as to achieve the same effect.

In one further form of this invention, there is proposed a punch for affecting an insertion of a barbed tubular connector through a wall of plastic tubing including;
a first member adapted to hold a barbed tubular connector in a ready to be inserted position;
a second member including a shaft with a shaft at the other end, held with respect to the said first member, such that it can be caused to move between any of three positions, these being a first position where the shaft is supported in a withdrawn position with respect to any connector that might be held in a ready to be inserted position by the said first member, the second position being where the shaft is inserted before any connector that might be held in a ready to be inserted position by the said first member, and the third position is where the tubular connector has been engaged, and together with the shaft, has been caused to move to a barbed tubular connector plastic tubing insertion position.

In preference, there is included a third member to hold, relative to the other members, of the plastic tubing.

In preference, the third member includes a channel into which the tubing is adapted to nest such that the sides could be kept from undue spreading when subjected to an insertion of the tubular connector.

In preference, the first member is adapted to hold at least two barbed tubular connectors, and is such that upon a first connector being pushed into an inserted position with respect to a plastic tubing and the shaft of the second member being withdrawn, that the second connector will then be urged into a ready inserted position with respect to the said first member.

In preference, the first member is arranged at the ready to be inserted position to receive a connector where this is moved laterally with respect to its tubular axis in a ready to be inserted position, and then to allow this to be moved in the direction of its axis when being moved to an inserted position by the said second member.

In preference, the first member includes a channel to receive with sliding freedom, a plurality of tubular connectors, the channel being aligned with the ready to be inserted position, so that tubular connectors can be charged from a chute provided by the channel.

In preference, at the ready to be inserted position, there is a release arrangement such that, when subjected to axial pressure, a tubular connector will be able to be pushed from this position into a plastic tubing insertion position.

In preference, there is a resilient locator at the ready to be inserted position such that it can be deflected under axial pressure from a tubular connector so as to allow the tubular connector to be thereby moved axially relatively thereto.

In preference, the first and second members are held together by a pivot connection.

In preference, the third member is pivotally held to the said first and second members.

### BRIEF DESCRIPTION OF THE DRAWINGS

This invention will be better understood when described with the assistance of drawings wherein:

FIG. 1 is a cross-sectional view illustrating in combination the punch including a tubular connector and a shaft at the point piercing into the wall of a larger diameter tubing;

FIG. 2 is the same view as in FIG. 1 where the piercing action has progressed further to the stage where the tubular connector is pushed fully through the wall so that its barb is part way through the peripheral edge defined by the pierced hole of the large diameter tubing;

FIG. 3 shows the position in which the barb is fully through the peripheral edge as defined by the pierced tube in the larger diameter tubing;

FIG. 4 illustrates the next stage in which the punch is lifted so that the shaft extracts itself from passing through the bore of the tubular connector;

FIG. 5 illustrates the position of a cutter blade being bought into an operating position, and being used to cut the larger diameter tubing;

FIG. 6 illustrates a resetting of a tubular connector on the shaft ready to be further inserted into a next spaced apart location on the larger diameter tubing; and

FIG. 7 is a cross-sectional view through a barbed tubular connector when located on the shaft in a position pushing the tubular connector through the pierced hole;

FIG. 11 is a side view of a punch in accordance with the embodiment illustrating the position of the legs prior to closing of these to effect an insertion of a tubular connector;

FIG. 12 is a perspective view of the connector as shown in FIG. 11;

FIG. 13 is the same view as in FIG. 12 with, however, the tubular connector removed from around the shaft, and the plastic tubing being shown in dotted outline in FIG. 2 being removed in FIG. 3; and

FIG. 14 is the same view as in FIG. 11 again being shown without the tubular connector or plastic tubing.

FIG. 15 is a perspective view of a punch according to the next embodiment shown in a position where it is about to insert a tubular connector into plastic tubing;

FIG. 16 is a side elevation of the punch as in FIG. 15 with, however the second member fully extracted;

FIG. 17 shows the next stage in the insertion action where the second member is being brought down so as to have its shaft pass fully through the tubular connector;

FIG. 18 is the next stage in which the first member pushes through the second member a tubular connector so as to have this pushed through into an engaging position into plastic tubing;

FIG. 19 is then the release position in which the said second member is fully extracted after having inserted the tubular connector into a position in the plastic tubing;

FIG. 20 illustrates in a perspective the tubular connector with the shaft and surrounding portion of the second member entering into the tubular connector; and

FIG. 21 is a perspective of the portion of the first member where a tubular connector is to be located in a ready to be inserted position so that it can be pushed through in an axial position once the tubing makes the first ready to be inserted location.

### BEST MODE FOR CARRYING OUT THE INVENTION

Referring in detail to the drawings, there is provided a punch 1 which includes a base 2 and a channel 3 defining two sides 4 and 5 within which a thin walled plastics tubing 6 is located and held in a relatively squeezed manner.

The punch 1 also includes a relatively moveable upper member 7 which carries on a pivotally supported arm 8 a shaft 9 which is of circular cross-section and has a length longer than the tubular connector 14.

This means that the shaft 9 protrudes at its end at 11 and it has a sharpened end at its outermost end at 12.

Otherwise the characteristic of this shaft is such that it is of slightly lesser diameter than the internal diameter of a bore 13 of a barbed tubular connector 14.

The tubular connector 13 has barbs at each end in conventional manner so that when they pass through an appropriately shaped hole in the wall of the larger diameter tubing 6 they will effect a water sealably engagement therewith.

Insertion of such barbed tubular connectors is known previously but conventionally requires a separate tool with a sharp end and a shaft having a very short length.

Accordingly, such a shaft is used to push the sharp end through the tubular wall and then a tubular connector would be separately held and pushed into the aperture so as to fully pass through into the centre of the tube with the barb.

In this embodiment, these two actions are combined so that by having a longer shaft and having the barbed tubular connector with the sharp extending fully through the bore of such a barbed connector, then it is one pushing action that can achieve both the piercing of the hole and the installing of the barbed connector.

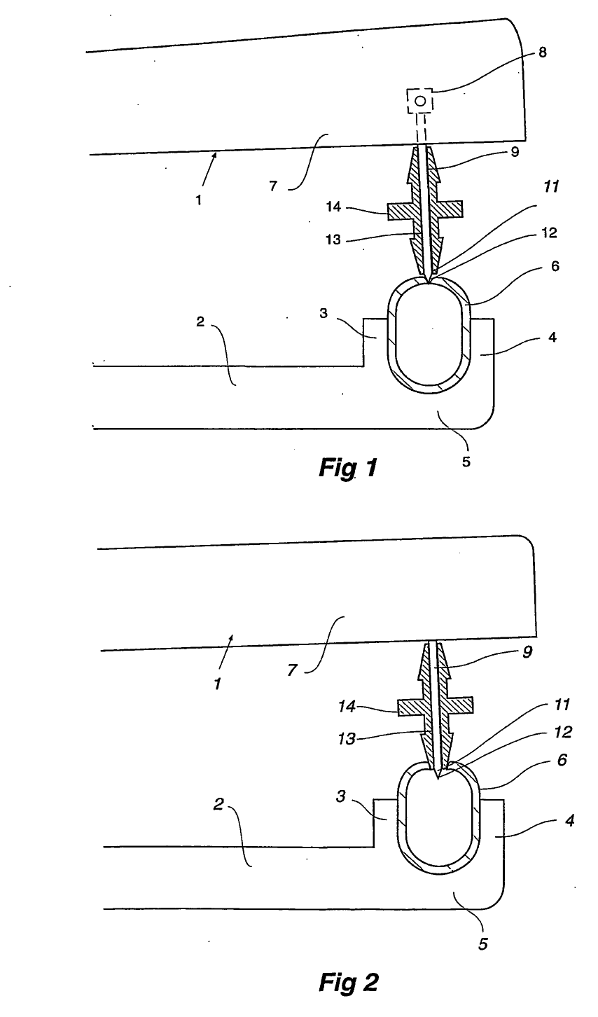

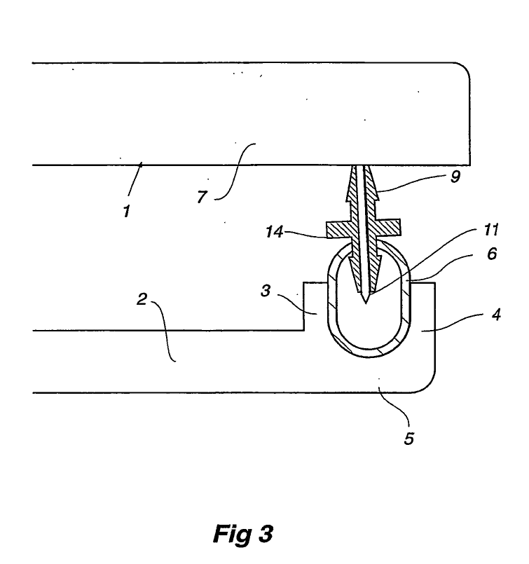

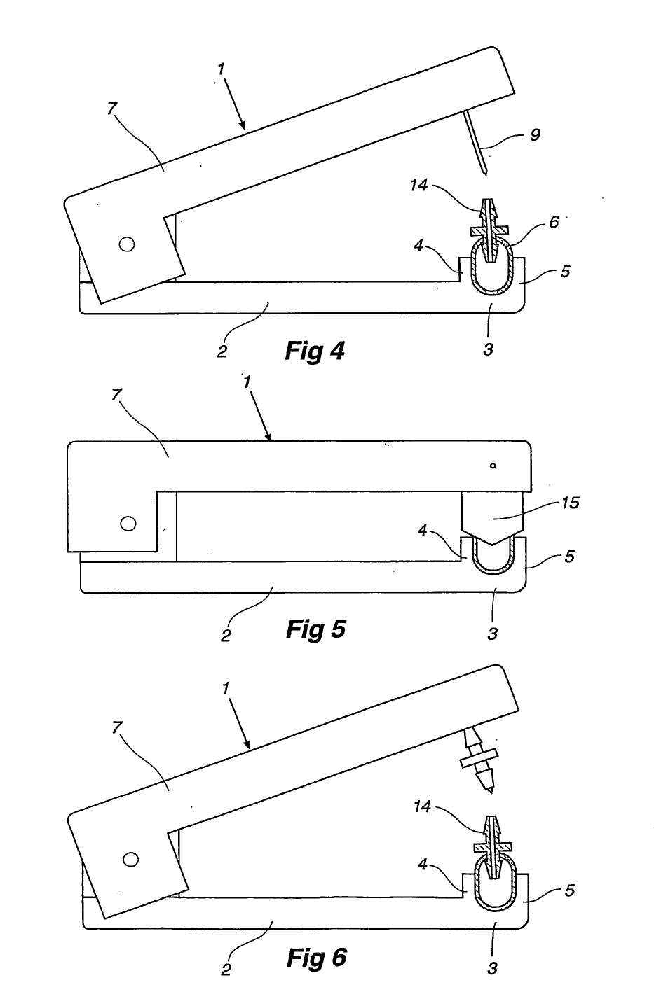

An advantage of this arrangement is that a punch can be used in which the shaft 9 can be variously positioned in an operating position as is shown in FIG. 1 or it can be pivotally swung away out of an operating position into a stored position.

When in a stored position, any other implement can then be brought into an operating position and, in this case, there is a blade 15 which is also pivotally supported with respect to the arm 7 so that it can be swung down and used to simply cut through a length of larger diameter tubing.

While the effort involved in conventional techniques is not arduous when small numbers of installations are involved, what has been found is that for those who need to install large numbers of these, there arises substantial continued effort and the advantage of the invention both in relation to the apparatus and to the method of using this provides significant reduction in effort and particular it eases the effort needed by an operator's hands.

What has not been described but which is also an extension of this invention is the use of two or more tubular connectors on the same shaft where subsequent to a first insertion, a second and possibly subsequent tubular connector is pushed so that a lower end is in the adjacent vicinity of the outermost sharp end of the shaft and a clamp engages behind the then next selected tubular connector so that this is then pushed with the insertion action into a next spaced apart location in a larger diameter tubing.

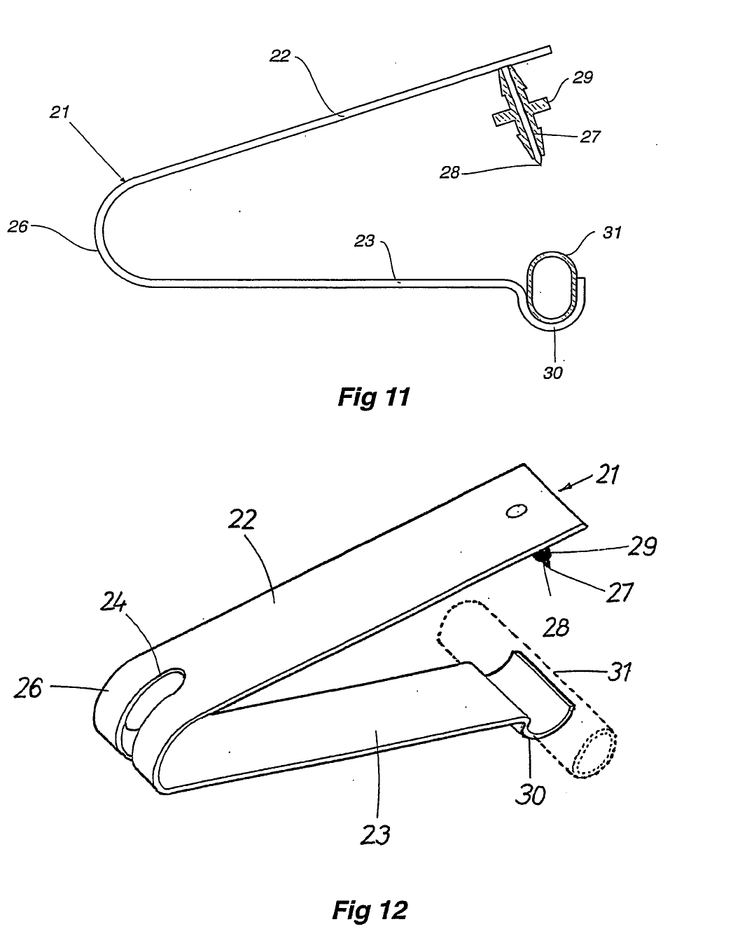

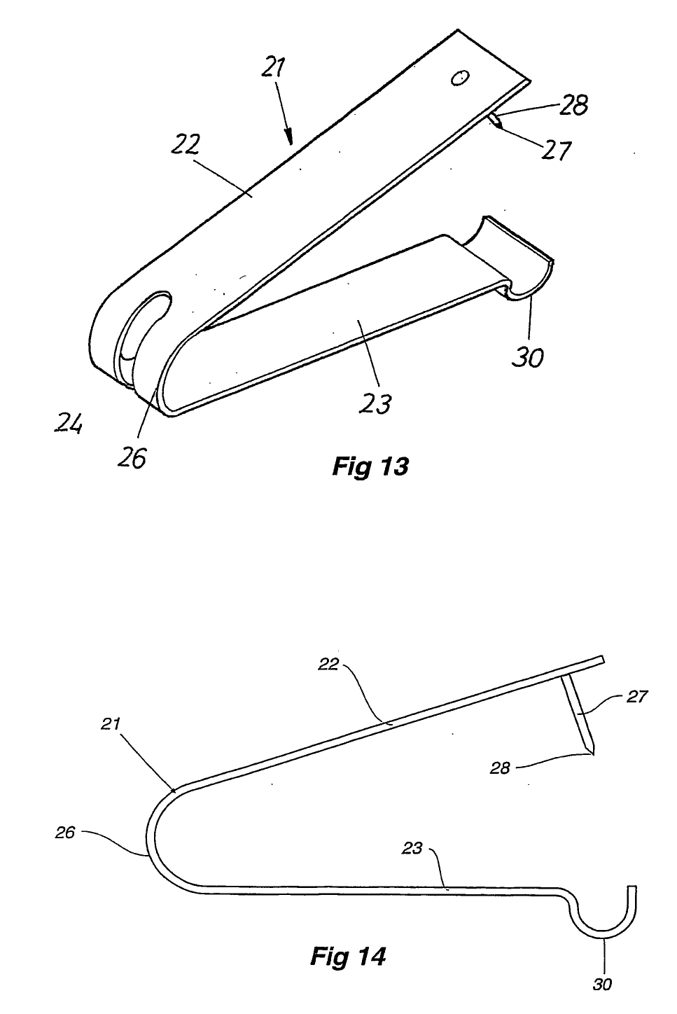

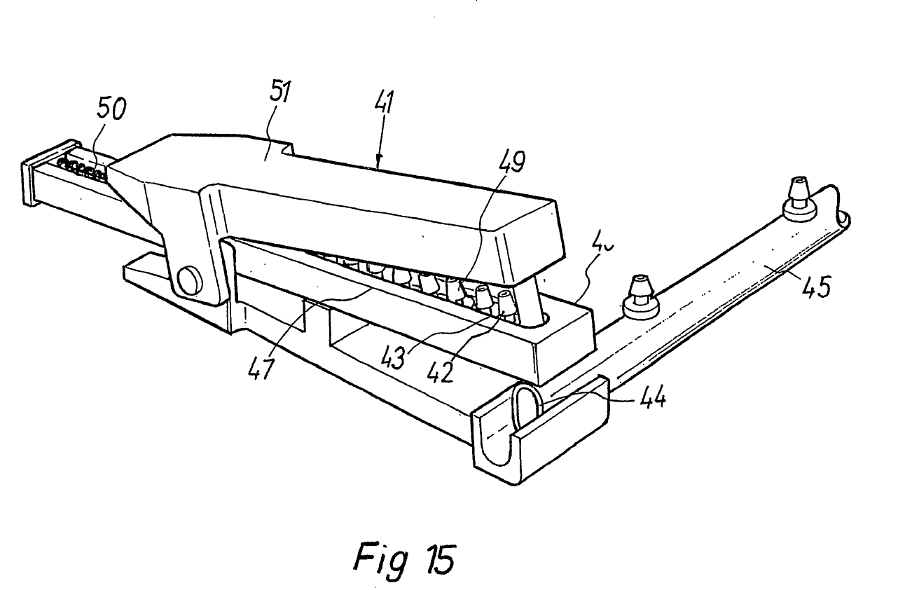

Now referring in detail to the drawings FIGS. 11,12, 13 and 14, the punch 21 is made from spring steel which is cut from a strip having a substantially uniform width throughout its length.

An advantage of this is that this can therefore be manufactured in bulk by use of a single die.

The width, however, is chosen for comfort for the hands of an operator and this will provide a relatively strong resistance in closing between upper leg 22 and lower leg 23.

In order to lessen the spring resistance, there is there provided in this instance a slotted aperture shown at 24.

This reduces the amount of the material at the apex location 26 and makes it therefore easier to close the respective legs 22 and 23.

A shaft 27 which has a sharp end at 28 is secured permanently to an end of the leg 22 so as to project transversely to this.

The shaft 27 is chosen so that it will in fact pass fully through the axial tubular center of a barbed connector such as is shown at 29.

At the outer end of leg 23 there is also bent a U-shape shown at 30 which has, for its purpose, to hold laterally a plastic tubing 31 so that the otherwise circular cross-sectional shape of the tubing 31 will be squeezed, first of all thereby providing better resistance to piercing of the sharp point 28 of the shaft 27 and also to hold firmly the tubing 31 in position with respect to the punch 21.

In the examples shown, the spring steel is 20 mms width and 1.5 mms thick. The steel shaft is 2.24 mms in diameter and has a full length of 26 mms.

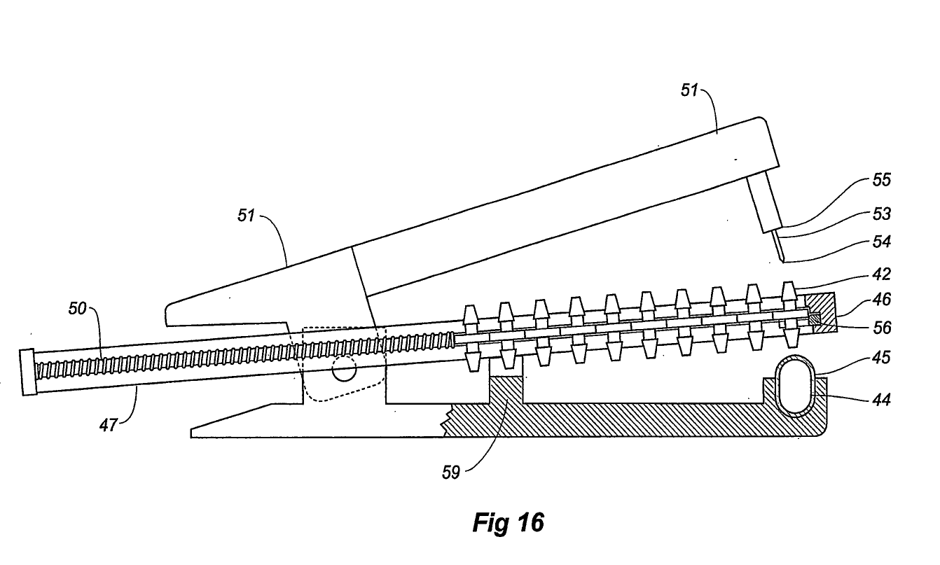

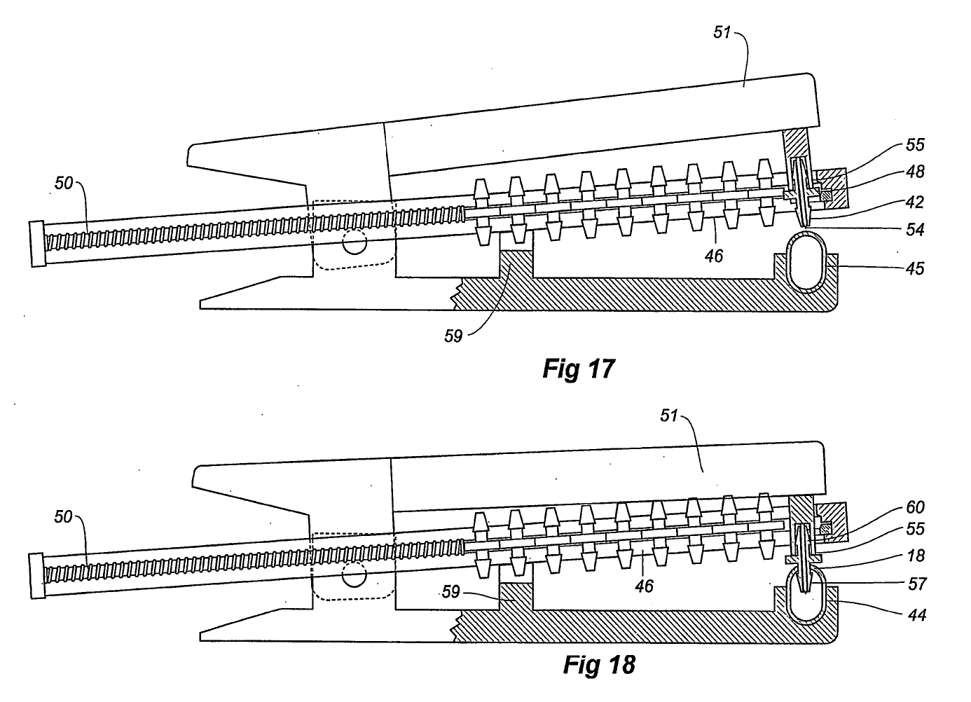

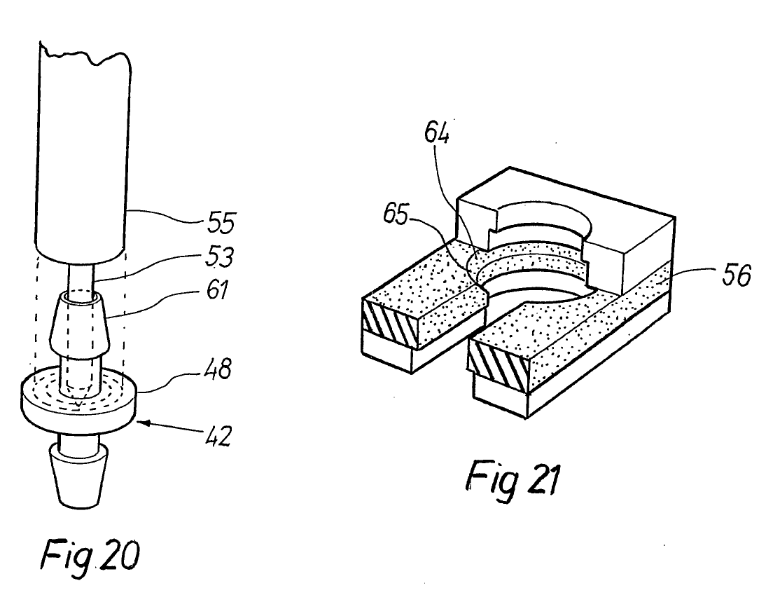

Referring in detail to the drawings FIGS. 15-21, there is a punch 41 which is adapted to insert a barbed tubular connector 42 from a ready to be inserted position at 43 into the wall 44 of a plastic tubing 45.

There is accordingly, a first member 46 which includes channels on each of two sides at 47 which hold a middle skirt shown typically at 48 of tubular connectors 49 so that these can be held in a channel under spring pressure of the helical spring 50.

In this way, a number of these barbed tubular connectors are ready to be fed into the ready to be inserted position 43 upon in sequence a one of these being inserted into the plastic tubing 45.

A second member 51 is pivotally secured with respect to the first member 46 so that as it is rotated in the direction of the arrow 52, a downwardly projecting shaft 53 with a sharp end at 54 will coincide with the mouth of the axial tube within the connector 42 and then pass fully through this.

Further, there is an outer abutment 55 which is arranged to engage the skirt 48 so that as the sharp end 54 of the shaft 53 projects and extends fully and slightly beyond the circular bore of the tubular connector 42, the abutment 55 engages the skirt 48 and thereby pushes this from the ready to be inserted position in which it is held by a resilient U shaped member 56.

With the sharpened end 54 projecting just beyond the tubular connector 42, this then is the sharp point that will push against the wall 44.

In this way, the sharpness of a metal shaft is used to ease the entry into a wall of plastic such as a polythene plastic material.

The action is continued until the position is reached as in FIG. 18 in which the barbed end shown at 57 is fully passed the surrounding now fractured wall 18 of the tube 44.

At this stage then, the downward freedom of the first member 46 is restricted by encountering resistance against stop 59.

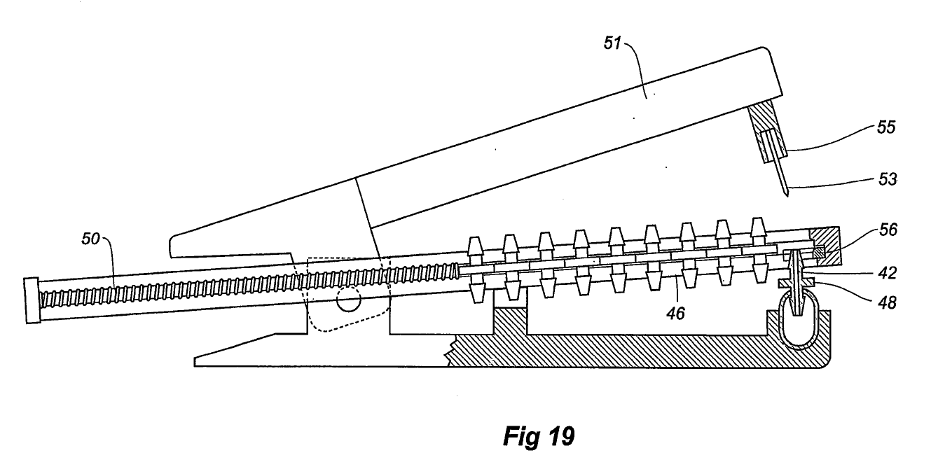

The said second member 51 is then lifted to assume the position as in FIG. 19.

As is shown especially in these cross sectional views, there is an annular space at 60 between the abutment 55 and the shaft 53 to allow for the upper end 61 of the tubular connector 42 to pass to allow the abutment 55 to engage against the skirt 48.

In practice, this arrangement then provides for very rapid insertion into plastic tube of tubular barbed connectors.

The shape of the resilient material at 56 which is arranged to locate firstly and hold each respective tubular connector as it is pushed into the ready to be inserted position includes resilient materials defining a substantially circular periphery at 64 which includes in cross section an upper tapered portion 65 which is arranged and selected so as to provide adequate support in a lateral way when a tubular connector is inserted therein but allow for lateral freedom once the shaft 53 has passed therethrough and the abutment 55 engages the skirt of the connector for further planting into an insertion position.

From this description then it will be seen that there is described an embodiment which will be of significant value to those requiring to insert tubular connectors.

In practice, this is now found to provide a very economic way of providing a punch for extensive insertion of barbed tubular connectors into plastic tubing.

1. A punch having a shaft with an outermost sharp end having a diameter and shape such that it will pass fully through the bore of a barbed tubular connector, and means at an inner end of such a shaft whereby to impinge any tubular connector positioned on the shaft so as to enable such a position connector to be pushed with the shaft into an installed position in the wall of a tube.

2. A method of installing a tubular connector which includes the steps of inserting through a central bore of a connector, a shaft having an outermost sharp end and then pushing the sharp end of the shaft through the wall of a tube while, at the same time, pushing the barbed connector so that the barb of the connector passes through and past a periphery of the wall where pierced, and then withdrawing only the shaft.

3. A punch as in claim 1 further characterized in that there are means to hold the plastic tubing which is to be pierced in such a way that the sides of the tube will be retained.

4. A method as in claim 2 further characterized in that there are means to hold the plastic tubing which is to be pierced in such a way that the sides of the tube will be retained.

5. A punch which has a base, a relatively movable arm supported by the base and a shaft with an outermost sharp end having a diameter and a sharp such that it will pass fully through the bore of a barbed tubular connector, the shaft extending in the vicinity of an outer end of the arm and extending transversely to any expected relative movement of the arm with respect to the base.

6. A punch as in preceding claim 5 further characterized in that the shaft is such so that it can be positioned in at least two relative positions one being a stored position and another being an operating position.

7. A punch as in claim 5 further characterized in that there is supported on the base a channel adapted to hold tubing between oppositely facing sides and adapted to restrict outward movement of opposite sides of the wall of plastic tubing when being pierced by the shaft.

8. A punch as in claim 5 further characterized in that there is also connected to the arm, a blade adapted to be positioned in two relative positions one of which is a stored position, and another of which is an operating position, the operating position being such that when the arm is brought together with the base, the blade is adapted to cut through any plastic tubing that might be being held relative to the base.

9. A combination punch and inserter for inserting a barbed tubular connector into a larger diameter plastics tubing, the inserter having a shaft having a sharp end and being of a size and shape adapted to extend fully through from end to end of the bore of a barbed tubular connector, and means with the shaft to engage an outer end of the tubular connector when positioned with the shaft extending through the bore of the tubular connector to push against the tubular connector so that this will follow a piercing action of the shaft into the wall of a larger diameter tubing.

10. A combination punch and inserter for inserting a barbed tubular connector into a larger diameter plastics tubing as in claim 9 further characterized in that the means with the shaft being to an extend that the barb of a tubular connector can pass fully through such a wall of plastics tubing subsequent to being pierced, and then extract the shaft by pulling this back through the bore of the tubular connector thereby leaving the tubular connector installed.

11. A method of installing a barbed tubular connector in the wall of a large diameter plastics tubing which includes the steps of locating a barbed tubular connector with a shaft extending fully through a tubular bore of a connector and having an outermost sharper end which projects past the bore of the tubular connector, and then effecting a piercing action with the shaft into the wall of the tubing and effecting a pushing of the connector synchronously with the shaft so as to have its barb fully in the wall of the tubing and then extracting the shaft.

12. A tool for supporting an insertion shaft with an outermost sharp end having a diameter and a shape such that it will pass fully through the bore of a barbed tubular connector, by which the tubular connector can be impinged and caused to be inserted through the wall of a plastic tubing, characterized in that the tool is substantially formed from a single strip of metal with an attached shaft.

13. A tool as in claim 12 further characterized in that the metal is spring steel.

14. A tool as in claim 13 further characterized in that the shape of the strip metal includes at one end an open U-shape nest into which plastic tubing can be squeezed and held thereby, and at an opposite end, there being secured a shaft so that respective legs can be pressed together whereby the end of the shaft would engage any plastic tubing held by the U-shaped end portion.

15. A tool as in claim 12 further characterized in that the strip metal is of substantially uniform width throughout its length, this being provided by a lower leg, an upper leg and an apex.

16. A tool as in claim 12 further characterized in that in the vicinity of the apex, there is at least one slotted hole through the metal whereby to provide an area of weakness to assist in control of the degree of spring resistance that might be encountered by a user.

17. A tool as in claim 12 further characterized in that the area in the vicinity of the apex is wasted whereby to provide a line of weakness to assist in control of the degree of spring resistance that might be encountered by a user.

18. A punch for affecting an insertion of a barbed tubular connector through a wall of plastic tubing including; a first member adapted to hold a barbed tubular connector in a ready to be inserted position; a second member including a shaft with a shaft at the other end, held with respect to the said first member, such that it can be caused to move between any of three positions, these being a first position where the shaft is supported in a withdrawn position with respect to any connector that might be held in a ready to be inserted position by the said first member, the second position being where the shaft is inserted before any connector that might be held in a ready to be inserted position by the said first member, and the third position is where the tubular connector has been engaged, and together with the shaft, has been caused to move to a barbed tubular connector plastic tubing insertion position.

19. A punch as in claim 18 further characterized in that there is included a third member to hold, relative to the other members, the plastic tubing.

20. A punch as in claim 19 further characterized in that the third member includes a channel into which the tubing is adapted to nest such that the sides could be kept from undue spreading when subjected to an insertion of the tubular connector.

21. A punch as in claim 16 further characterized in that the first member is adapted to hold at least two barbed tubular connectors, and is such that upon a first connector being pushed into an inserted position with respect to a plastic tubing and the shaft of the second member having been withdrawn, that the second connector will then be urged into a ready inserted position with respect to the said first member.

22. A punch as in claim 16 further characterized in that the first member is arranged at the ready to be inserted position to receive a connector where this is moved laterally with respect to its tubular axis in a ready to be inserted position, and then adapted to allow this to be moved in the direction of its axis when being moved to an inserted position by the said second member.

23. A punch as in claim 16 further characterized in that the first member includes a channel to receive with sliding freedom, a plurality of tubular connectors, the channel being aligned with the ready to be inserted position, so that tubular connectors can be charged from a chute provided by the channel.

24. A punch as in claim 16 further characterized in that at the ready to be inserted position, there is a release arrangement such that, when subjected to axial pressure, a tubular connector will be able to be pushed from this position into a plastic tubing insertion position.

25. A punch as in claim 16 further characterized in that there is a resilient locator at the ready to be inserted position such that it can be deflected under axial pressure from a tubular connector so as to allow the tubular connector to be thereby moved axially relatively thereto.

26 A punch as in claim 16 further characterized in that the first and second members are held together by a pivot connection.

27 A punch as in claim 16 further characterized in that the third member is pivotally held to the said first and second members.
